(19) United States
(12) Patent Application Publication
(10) Pub. No.: US 2024/0281652 A1
(43) Pub. Date: Aug. 22, 2024

(54) TRAINING METHOD AND TRAINING SYSTEM FOR NEURAL NETWORK MODEL

(71) Applicant: InSign Medical Technology (Hong Kong) Ltd., Hong Kong (CN)

(72) Inventors: YI-TA WU, Hong Kong (CN); KUANG-TING HSIAO, Hong Kong (CN); FU-CHIEH CHANG, Hong Kong (CN)

(21) Appl. No.: 18/205,103

(22) Filed: Jun. 2, 2023

(30) Foreign Application Priority Data
Feb. 16, 2023 (CN) 202310125389.1

(51) Int. Cl. G06N 3/08

(52) U.S. Cl. CPC G06N 3/08

(57) ABSTRACT

A training method and training system for neural network model. The training method includes: (a) receiving image data; (b) preforming first-tier calculation including first convolution and first non-linear calculation; (c) performing combination computation; (d) performing second-tier calculation based on output of the combination computation when it is determined to execute, and it includes second convolution and second non-linear calculation; and (e) when the second-tier calculation is determined not to execute, classifying the output of the combination computation. Step (c) includes: (c1) grouping output of the first-tier calculation; (c2) performing linear and non-linear computation respectively on different groups of the output of the first-tier calculation; and (c3) performing consolidate computation based on output of the linear and the non-linear computation. The output of the combination computation is generated at least based on the image data after the first-tier calculation and one of a mathematical operator and a non-linear operator.

### RELATED APPLICATIONS

This application claims priority to China Patent Application, No. 202310125389.1, by WU, et al., titled “TRAINING METHOD AND TRAINING SYSTEM FOR NEURAL NETWORK MODEL,” filed Feb. 16, 2023, which is hereby incorporated by reference herein in their entirety.

### BACKGROUND OF THE INVENTION

### Technical Field

The present invention relates to artificial intelligence that is implemented in neural network. More particularly, the present invention relates to training method and training system for neural network model.

### Description of Related Art

Computer learning is one of the major methods to implement artificial intelligence. In particular, computer learning and training based on algorithms constructed by neural networks have become the mainstream of implementations of artificial intelligence.

One of the widely used applications of artificial intelligence is image processing and image recognition. First a certain type of neural network model is trained by using multiple known and classified images. Then the trained neural network model can be used to classify unknown images. However, there still exists a need for making the models more sensitive to certain image features and therefore to detect such subtle image features more efficiently.

### SUMMARY

In view of the above-mentioned problems, the present invention is to provide a training method and training system for neural network model. By integrating the parameters relating to linear and non-linear calculation, the neural network model can be more efficient and then establishes a robust and efficient deep learning framework.

According to one aspect of the invention, a training method is provided. The training method includes the following steps: (a) receiving an image data; (b) preforming a first-tier calculation including a first convolution calculation and a first non-linear calculation by using the image data; (c) performing a combination computation; (d) when a second-tier calculation is determined to be executed, performing the second-tier calculation including a second convolution calculation and a second non-linear calculation based on an output of the combination computation; and (e) when the second-tier calculation is determined not to be executed, classifying the output of the combination computation. The step (c) of performing the combination computation includes: (c1) grouping an output of the first-tier calculation; (c2) performing a linear computation and a non-linear computation respectively on different groups of the output of the first-tier calculation; and (c3) performing a consolidate computation based on an output of the linear computation and an output of the non-linear computation. The output of the combination computation is generated at least based on the image data after the first-tier calculation and one of a mathematical operator and a non-linear operator.

In one embodiment, the output of the combination computation is further based on the image data after at least once of the second-tier calculation.

In another embodiment, the second-tier calculation is performed W times, and the training method further includes: (f) determining whether a w+1 time second-tier calculation is performed or not, where w is an integer from 0 to W.

In another embodiment, the first convolution calculation is performed N times and an output of the n−1 time first convolution calculation is regarded as the image data for the n time first convolution calculation, where N≥2 and N≥n≥2. The step (c) is performed based on the output of the N time first convolution calculation and an output of the first non-linear calculation.

In another embodiment. the first non-linear calculation is performed M times and an output of the m−1 time first non-linear calculation is regarded as the image data for the m time first non-linear calculation, where M≥2 and M≥m≥2. The step (c) is performed based on the output of the M time first non-linear calculation and an output of the first convolution calculation.

In another embodiment, the training method further includes one or any combination of the following steps: changing a dimension of an output of the first convolution calculation and/or an output of the second convolution calculation; and updating the output of the first convolution calculation and/or the output of the second convolution calculation based on an activation function.

In another embodiment, training method further includes one or any combination of the following steps: changing a dimension of an output of the first non-linear calculation and/or an output of the second non-linear calculation; and updating the output of the first non-linear calculation and/or the output of the second non-linear calculation based on an activation function.

In yet another embodiment, the mathematical operator includes one or any combination of the following: addition, subtraction, multiplication, division, and power value.

In a further embodiment, the non-linear operator includes one or any combination of the following: acquiring a maximum value, acquiring a minimum value, and acquiring a mean value.

According to another aspect of the invention, a training system is provided. The training system includes an I/O interface and a processor. The I/O interface is configured for receiving an image data. The processor is configured for preforming a first-tier calculation including a first convolution calculation and a first non-linear calculation by using the image data and performing a combination computation including: grouping an output of the first-tier calculation; performing a linear computation and a non-linear computation respectively on different groups of the output of the first-tier calculation; and performing a consolidate computation based on an output of the linear computation and an output of the non-linear computation. The processor is further configured for performing a second-tier calculation including a second convolution calculation and a second non-linear calculation based on an output of the combination computation when the second-tier calculation is determined to be executed and classifying the output of the combination computation when the second-tier calculation is determined not to be executed. The output of the combination computation is generated at least based on the image data after the first-tier calculation and one of a mathematical operator and a non-linear operator.

According to yet another aspect of the invention, a training system is provided. The training system includes a memory and a processor. The memory is configured for storing the neural network model. The processor is configured for performing a training method so as to train the neural network model. The training method includes: (a) receiving an image data; (b) preforming a first-tier calculation including a first convolution calculation and a first non-linear calculation by using the image data; (c) performing a combination computation, including: (c1) grouping an output of the first-tier calculation; (c2) performing a linear computation and a non-linear computation respectively on different groups of the output of the first-tier calculation; and (c3) performing a consolidate computation based on an output of the linear computation and an output of the non-linear computation; (d) when a second-tier calculation is determined to be executed, performing the second-tier calculation including a second convolution calculation and a second non-linear calculation based on an output of the combination computation; and (e) when the second-tier calculation is determined not to be executed, classifying the output of the combination computation. The output of the combination computation is generated at least based on the image data after the first-tier calculation and one of a mathematical operator and a non-linear operator.

According to the embodiments of the invention, the combination computation process is used in the training method and training system to integrate the parameters relating to linear and non-linear calculation more efficiently. The trained neural network model is more efficient, and the image features obtained by the neural network model can be more distinct, which is beneficial to the subsequent classification process. Further, the neural network model established therefrom is more sensitive to certain image characteristics, and the image with these characteristics can be detected more accurately and more efficiently. The training method and training system can therefore achieve a robust and efficient deep learning framework.

### BRIEF DESCRIPTION OF DRAWINGS

The invention can be more fully understood by reading the following detailed description of the embodiment, with reference made to the accompanying drawings as follows:

FIG. 1 is a block diagram of a training system for neural network model according to one embodiment of the invention;

FIG. 2 is a flow chart of a training method S200 for neural network model according to one embodiment of the invention;

FIG. 3 is a flow chart of the combination computation according to one embodiment of the invention;

FIG. 4 is a schematic diagram showing multiple matrixes of image data output from the first-tier calculation;

FIG. 5 is a schematic diagram of the first group of data after the linear computation;

FIG. 6(a) is a schematic diagram of the second group of data after the non-linear computation;

FIG. 6(b) is a schematic diagram of the data of FIG. 6(a) after another non-linear computation;

FIG. 7(a) is a schematic diagram of the combination computation according to one embodiment of the invention;

FIG. 7(b) is a schematic diagram of the combination computation according to another embodiment of the invention;

FIG. 8 is a flow chart of the first-tier calculation according to one embodiment of the invention;

FIG. 9 is a flow chart of the first convolution calculation according to one embodiment of the invention;

FIG. 10 is a flow chart of the first convolution calculation being performed four times according to one embodiment of the invention;

FIG. 11 is a flow chart of the first non-linear calculation according to one embodiment of the invention;

FIG. 12 is a flow chart of the first non-linear calculation being performed four times according to one embodiment of the invention;

FIG. 13 is a flow chart of the convolution process S2211 according to one embodiment of the invention;

FIG. 14 is a flow chart of the non-linear calculation process S2221 according to one embodiment of the invention;

FIG. 15(a) is one example of the input image data;

FIG. 15(b) is the mask used in step S520 according to one embodiment of the invention;

FIG. 15(c) is the mask used in step S620 according to one embodiment of the invention;

FIG. 16(a) is the padded image of the input image data of FIG. 15(a) after step S510 or step S610;

FIG. 16(b) is a schematic diagram showing the calculation at location Img(1,1) in step S620;

FIG. 16(c) is a schematic diagram showing the calculation result at location Img(1,1);

FIG. 16(d) is a schematic diagram of the value of the calculation result being input in Img(1,1);

FIG. 16(e) is a schematic diagram showing step S660 where all the pixel values of the image data have been processed through the non-linear calculation step S2221;

FIG. 17(a) to FIG. 17(e) show the schematic diagrams of the non-linear calculation process S2221 according to another embodiment of the invention;

FIG. 18 is a flow chart of the second-tier calculation according to one embodiment of the invention;

FIG. 19 is a schematic diagram of a training system according to one embodiment of the invention;

FIG. 20 is a schematic diagram of the first convolution calculation submodule; and

FIG. 21 is a schematic diagram of the first non-linear calculation submodule.

### DETAILED DESCRIPTION

The present disclosure will now be described more fully hereinafter with reference to the accompanying drawings, in which exemplary embodiments of the disclosure are shown. This disclosure may, however, be embodied in many different forms and should not be construed as limited to the exemplary embodiments set forth herein. Rather, these exemplary embodiments are provided so that this disclosure will be thorough and complete, and will fully convey the scope of the disclosure to those skilled in the art. Like reference numerals refer to like elements throughout.

The embodiments of the present invention disclose training method and training system for neural network model. A first-tier calculation including a first convolution calculation and a first on-linear calculation is performed on the received image data. Then a combination computation is performed on the output of the first-tier calculation. The combination computation includes grouping the output of the first-tier calculation, performing a linear computation and a non-linear computation respectively on different groups of the output of the first-tier calculation, and performing a consolidate computation based on an output of the linear computation and an output of the non-linear computation. When a second-tier calculation is determined to be executed, performing the second-tier calculation including a second convolution calculation and a second non-linear calculation based on an output of the combination computation. The parameters relating to linear and non-linear calculation can be integrated more effectively based on the combination computation. The trained neural network model is more efficient and is more sensitive to image features. The efficiency of detecting the images and the accuracy of classifying the images can be improved, which is beneficial to various applications such as image classification and image processing calculation.

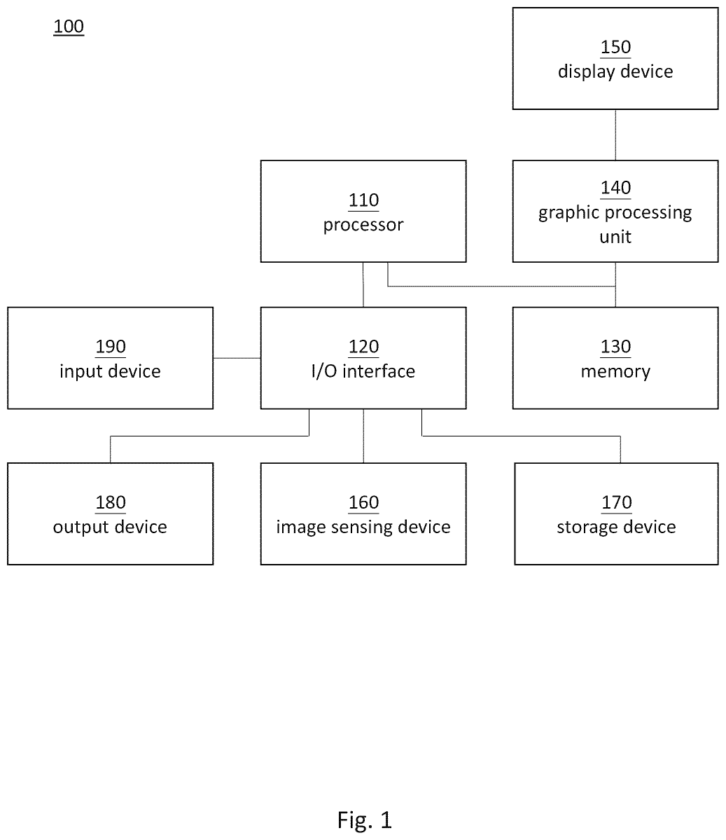

Please refer to FIG. 1, which is a block diagram of a training system for neural network model according to one embodiment of the invention. The training system 100 for the neural network model includes a processor 110 (e.g. central processing unit, CPU) which can be configured for executing an operating system, to control the operation of the training system 100. The present application does not limit the instruction set used by the processor 110, nor the operating system used by it. For instance, the processor 110 includes one or more processing chips, and each processing chip can include one or more processing cores. The instruction set used by the processing core may include arithmetic and logic operations, and in another embodiment, it may include specific vector instructions that are specialized for processing neural networks.

The training system 100 includes an I/O interface 120, which is configured for connecting to a variety of output device 180 and input device 190. For example, the output device 180 includes speaker, buzzer, light, or any combination thereof, which is used for notifying or alerting user. The input device 190 includes, for instance, keyboard, mouse, track ball, touch pad, scanner, microphone, or any combination thereof, which is used for inputting outside messages, information, or even image data to the training system 100. The I/O interface 120 can further connect to wired or wireless network device, commonly refer to device that complies with Bluetooth Wi-Fi, IEEE 802.3, 4G or 5G communication regulations to receive data.

The I/O interface 120 can be used to connect to image sensing device 160 and/or storage device 170. The image sensing device 160 exemplarily includes video or image sensing component for picking up lights across various spectrums. The image sensing device 160 includes a buffer memory for caching the detected images and later sending them to the processor 110 and/or a memory 130. In one embodiment, the image sensing device 160 can be endoscope, and the storage device 170 can be traditional floppy disc drive, optical disc drive, hard disc drive, or solid-state drive. In one embodiment, the image sensing device 160 and the storage device 170 are integrated in one device.

The memory 130 can include multiple stages of memory, such as the hierarchy of dynamic random access memory and static random access memory. The memory 130 is used for store instructions and data, such as the aforementioned operating system and applications usable on the operating system. In one embodiment, the memory 130 can also store the neural network model provided by the embodiments of the present application.

The training system 100 further includes a graphic processing unit 140. The processor 110 and the graphic processing unit 140 can share the memory 130 and transmit a large amount of data through the memory 130. The processor 110 and the graphic processing unit 140 can also be regarded as one integrated processor. One the other hand, the processor of the neural network training system 110 may include the central processing unit 110 and/or the graphic processing unit 140. The processing resource of the graphic processing unit 140 also facilitates the realization of the neural network model training method provided by the embodiments of the present application. Further, the training system 100 includes a display device 150 which connects to the graphic processing unit 140. The display device 100 is configured to display images before and after processing.

In one embodiment, the training system 100 for neural network model can further include a specific acceleration expansion circuit module for accelerating the calculation process used for the neural network model of the embodiments of present application. One skilled in the related art should have ordinary knowledge of computer organization and computer architecture, so he/she would understand the hardware configuration of the training system 100.

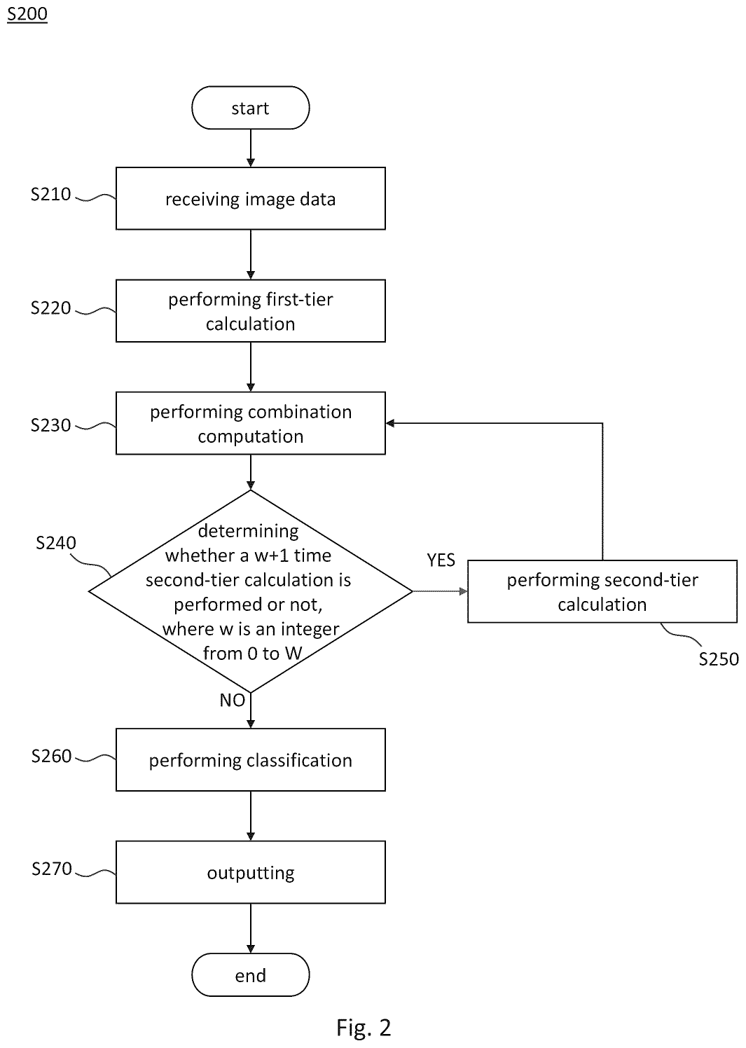

Please refer to FIG. 2, which is a flow chart of a training method S200 for neural network model according to one embodiment of the invention. The training method S200 can be implemented by the training system 100 for neural network model as elaborated in the above with FIG. 1. In one embodiment, one or more of the processor 110, the graphic processing unit 140, and specific acceleration expansion circuit module can execute multiple instructions to realize the training method 200 for the neural network model. The training method S200 is based on a data structure of neural network model. One skilled in the related art should have ordinary knowledge of computer neural network model, so he/she would understand that the computer neural network model includes multiple layers, and each layer includes multiple nodes. The nodes on two different layers have links between them, and each link has one or more trainable weight parameters. While training the neural network model, it is the weight parameters that are to be trained until the convergence of the model is reached.

The training method S200 for the neural network model of the present embodiment begins with step S210.

Step S210: an image data is received. The image data can come from the image sensing device 160; or in another embodiment, come from the storage device 170. The training method S200 continues to step S220.

Step S220: a first-tier calculation is performed based on the image data. The first-tier calculation includes a first convolution calculation and a first non-linear calculation. An output of the first-tier calculation is sent to step S230.

Step S230: a combination computation is performed based on the output of the first-tier calculation S220. The combination computation includes the following steps: grouping the output of the first-tier calculation; performing a linear computation and a non-linear computation on different groups of the result of the first-tier calculation; and performing a consolidate computation based on an output of the linear computation and an output of the non-linear computation. In this manner, the result of the convolution calculation and the non-linear calculation can be further integrated; thereby achieving an efficient and robust neural network model framework.

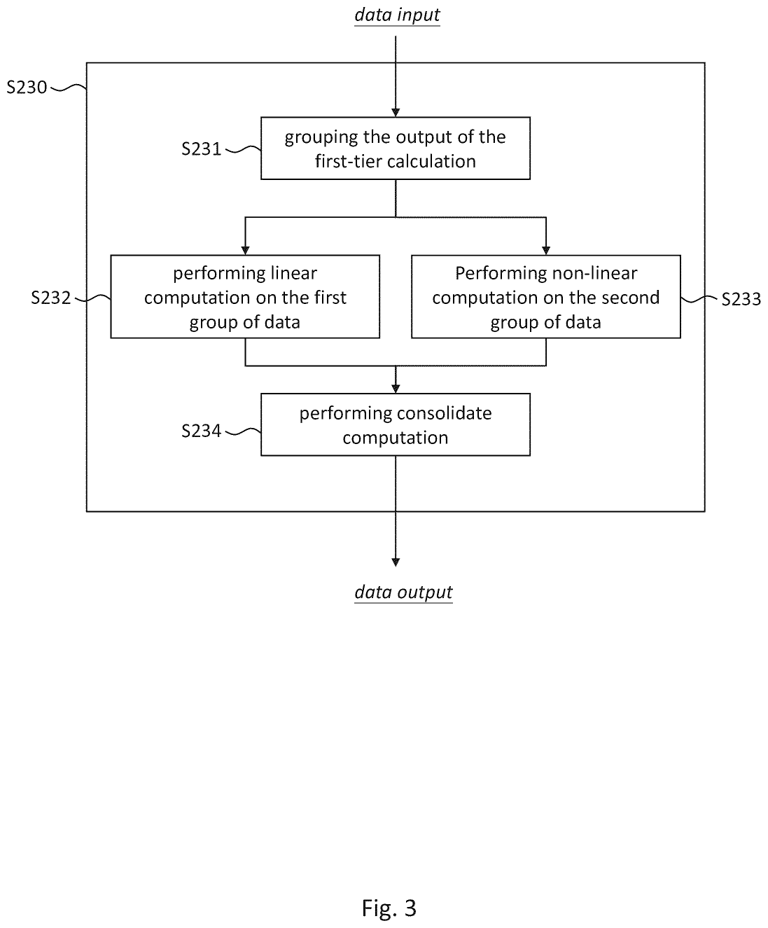

In the training method S200 according to the embodiments of the invention, an output of the combination computation S230 is generated at least based on the image data after the first-tier calculation and one of a mathematical operator and a non-linear operator. The details of the combination computation will further be elaborated below with FIG. 3 to FIG. 7(b). When step S230 is completed, the output of the combination computation is generated. The output will be sent to step S250 or step S260 according to determination conditions. When a second-tier calculation is determined to be executed, the output of the combination computation is sent to step S250, and then the training method S200 returns to step S230 where the combination computation is performed again. On the other hand, when the second-tier calculation is determined not to be executed, the output of the combination computation is sent to step S260. The training method S200 of the present embodiment further includes a determining step S240.

Step S240: determining whether a w+1 time second-tier calculation should be performed or not, where w is an integer from 0 to W and W is the times the second-tier calculation should be performed. When w+1 is smaller or equal to W, it is determined YES. When w+1 is larger than W, it is determined NO. W can be set based on the training needs of the neural network model. For example, when W=2 is set, it means the second-tier calculation S250 should be performed twice. When step S240 is performed for the first time, w=0 and w+1=1, which is smaller than W (which is 2), and then it is determined YES. The training method S200 moves on to step S250 to perform the second-tier calculation for the first time, and then returns to step S230 to perform the combination computation again. Then the training method S200 continues to step S240 again. When step S240 is performed for the second time, w=1 and w+1=2, which equals W, and then it is determined YES. The training method S200 performs step S250 again and then moves back to step S230. Afterwards, the training method S200 moves on to step S240 for the third time. When step S240 is performed for the third time, w=2 and w+1=3 which is larger than W, so it is determined NO. The training method S200 then continues to step S260. According to the determination of step S240, the combination computation S230 is performed at least based on the output of the first-tier calculation S220. When needed, the combination computation S230 can be performed further based on one or more second-tier calculations S250, thereby enhancing the integration of linear and non-linear calculation.

S250: when the second-tier calculation is determined to be executed, the second-tier calculation which includes a second convolution calculation and a second non-linear calculation is performed based on the output of the combination computation. The content of the second convolution calculation can be the same or different from that of the first convolution calculation. The content of the second non-linear calculation can be the same or different from that of the first non-linear calculation. When step S250 is finished, the training method S200 returns to step S230 to perform the combination computation again and then enters step S240 to perform the determination again. When it is determined NO, the training method S200 enters step S260.

Step S260: a classification process is performed on the output of the combination computation S230.

Step S270: the output of the training method S200 is provided, which completes the training method S200 of the present embodiment.

The combination computation of step S230 will be elaborated in more detail. Please refer to FIG. 3, which is a flow chart of the combination computation according to one embodiment of the invention. Step S230 includes the following steps:

Step 231: the output of the first-tier calculation is grouped. In one embodiment, the output of the first-tier calculation can be exemplified by t sets of 2D matrix of Nm*Nn, where Nm={1, 2, . . . , m} and Nn={1, 2, . . . , n}. The output of the first-tier calculation can be expressed in the following equation (1):

$${Set}_{All} = \{ {In}_{1} , {In}_{2} , … , {In}_{t} \} \qquad ( 1 )$$

For example, when the output of the first-tier calculation is received in step S231, the received data is grouped into 2 groups (sets): SetL and SetNL. The two groups (sets) of data matches the following criteria:

$${Set}_{L} ∈ {Set}_{All} ;$$

$${Set}_{NL} ∈ {Set}_{All} ;$$

$${Set}_{L} ⋂ {Set}_{NL} = ϕ ;$$

$$and {Set}_{L} ⋃ {Set}_{NL} = {Set}_{All} .$$

The above-mentioned relations mean the two data groups are independent from each other. Each 2D matrix would only be assigned to one group. After grouping, steps S232 and S233 are performed. The two steps can be performed individually, and the embodiment of the invention does not limit the priority of the two steps. They can be performed at the same time as well.

Step S232: a linear computation is performed on the first group of data. In the present embodiment, the first group of data is SetL; that is, the linear computation is applied on the data of SetL. In one embodiment, the mathematical operator L_OperatorSetL is used to carry out the linear computation. The mathematical operator includes one or any combination of the following: addition, subtraction, multiplication, division, and power value.

Step S233: a non-linear computation is performed on the second group of data. In the present embodiment. The second group of data is SetNL; that is, the non-linear computation is applied on the data of SetNL. In one embodiment, the non-linear operator NL_OperatorSetNL is used to carry out the non-linear computation. The non-linear operator includes one or any combination of the following: acquiring a maximum value, acquiring a minimum value, and acquiring a mean value.

Step S234, a consolidate computation is performed. The output of the linear computation of step S232 and the output of the non-linear computation of step S233 can be integrated. In the present embodiment, k sets of 2D matrix of Nm*Nn are generated. The k sets of data can be expressed in the following equation (2):

$$Combination {( {In}_{1} , {In}_{2} , … , {In}_{t} )}_{k} ( x , y ) = LNL\_Operator ( {L\_Operator}_{SetL} , {NL\_Operator}_{SetNL} ) \qquad ( 2 )$$

The LNL_Operator shown in the above equation (2) is an consolidate operator. After step S234, the combination computation of the present embodiment is completed. The output of the combination computation −k sets of 2D matrixes are sent to step S250 for the second-tier calculation; or alternatively sent to step S260 for classifying.

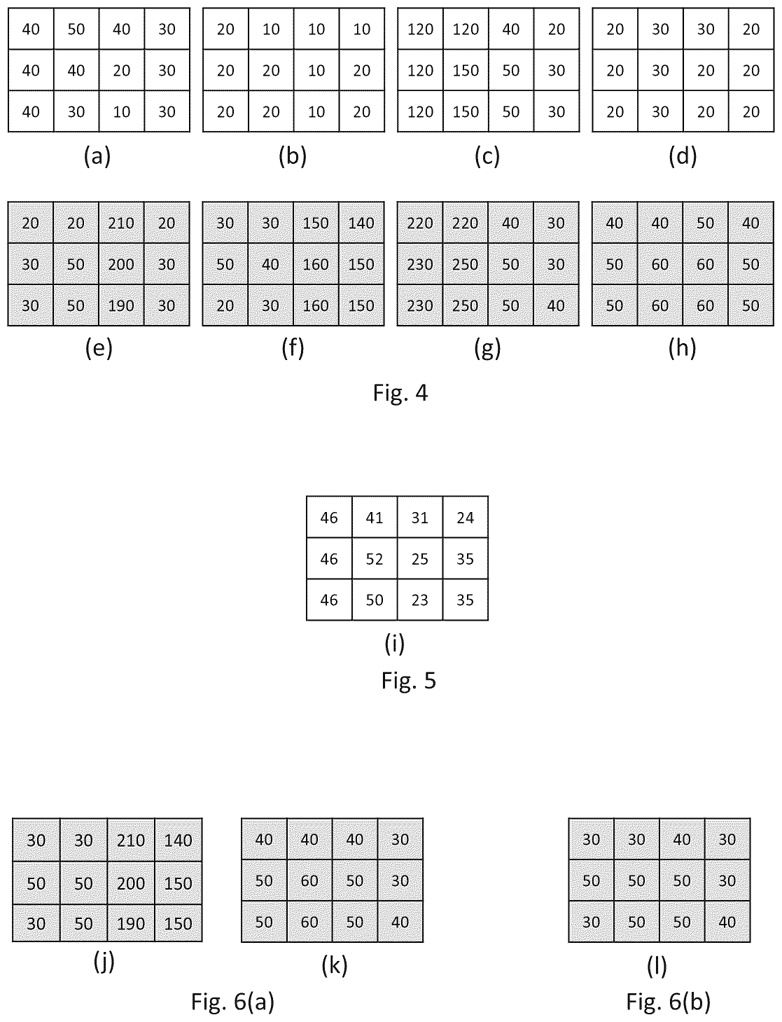

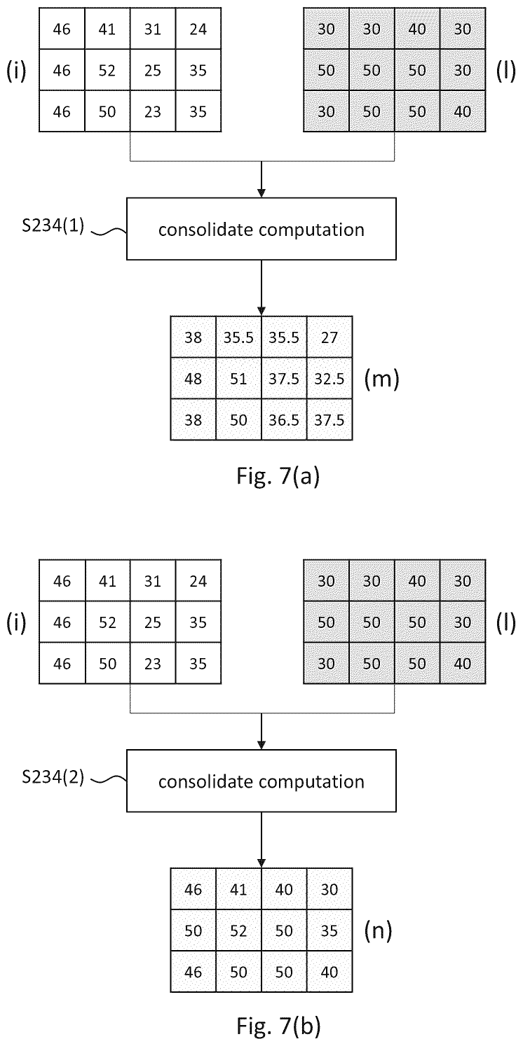

A practical example of the combination computation of step S230 is elaborated below with reference to FIG. 4 to FIG. 7(b). FIG. 4 is a schematic diagram showing multiple matrixes of image data output from the first-tier calculation. FIG. 5 is a schematic diagram of the first group of data after the linear computation. FIG. 6(a) is a schematic diagram of the second group of data after the non-linear computation. FIG. 6(b) is a schematic diagram of the data of FIG. 6(a) after another non-linear computation. FIG. 7(a) is a schematic diagram of the consolidate computation according to one embodiment of the invention. FIG. 7(b) is a schematic diagram of the consolidate computation according to another embodiment of the invention.

In one embodiment, t=8 in equation (1). There are eight 2D data matrixes (a)-(h) from the output of the first-tier calculation as shown in FIG. 4. Here in the present embodiment, matrixes (a)-(d) are grouped in the first group, and matrixes (e)-(h) are grouped in the second group. After the grouping step (step S231 in FIG. 3), matrixes (a)-(d) are included in SetL, and matrixes (e)-(h) are included in SetNL.

On one hand, the linear computation is applied to SetL, where the linear operator L_OperatorSetL in the present embodiment is defined in the following equation (3):

$${L\_Operator}_{SetL} = 0.2 * ( a ) + ( b ) + 0.1 * ( c ) + 0.3 * ( d ) \qquad ( 3 )$$

According to the computation of equation (3), the four matrixes (a)-(d) in FIG. 4 are converted into matrix(i) of FIG. 5, hence completing the linear computation.

On the other hand, the non-linear computation is applied to SetNL, where the non-linear operator NL_OperatorSetNL in the present embodiment is defined in the following equation (4):

$${NL\_Operator}_{SetNL} = min ( max ( ( e ) , ( f ) ) , min ( ( g ) , ( h ) ) ) \qquad ( 4 )$$

The two matrixes (e)&(f) are applied with the computation of acquiring the maximum value and converted into matrix (j) of FIG. 6(a). The other two matrixes (g)&(h) are applied with the computation of acquiring the minimum value and converted into matrix (k) of FIG. 6(a). Afterwards, the computation of acquiring the minimum value is applied to matrix (j) and matrix (k). As a result, matrix (I) of FIG. 6(b) is generated; hence completing the non-linear computation.

The consolidate computation is performed based on the result of the linear computation-matrix(i) and the result of the non-linear computation—matrix(I). In step S234(1) of FIG. 7(a), the consolidate operator LNL_Operator is defined in the following equation (5):

$$LNL\_Operator = 0.5 * {NL\_Operator}_{SetNL} + 0.5 * {L\_Operator}_{SetL} \qquad ( 5 )$$

The consolidate operator of step S234(1) is defined in the form of linear computation. After matrix(i) and matrix(I) go through the consolidate computation, matrix(m) of FIG. 7(a) is generated.

In another embodiment, the consolidate operator can be in the form of non-linear computation. In step S234(2) of FIG. 7(b), the consolidate operator LNL_Operator is defined in the following equation (6):

$$LNL\_Operator = max ( NL\_OperatorSetNL , L\_OperatorSetL ) \qquad ( 6 )$$

The consolidate operator of step S234(2) is defined in the form of non-linear computation. After matrix(i) and matrix(I) go through the consolidate computation, matrix (n) of FIG. 7(b) is generated.

The matrix(m) or the matrix(n) is the output of the combination computation of step S230. The matrix(m) or the matrix(n) can be sent to step S250 to perform the second-tier calculation, or to step S260 to perform classification.

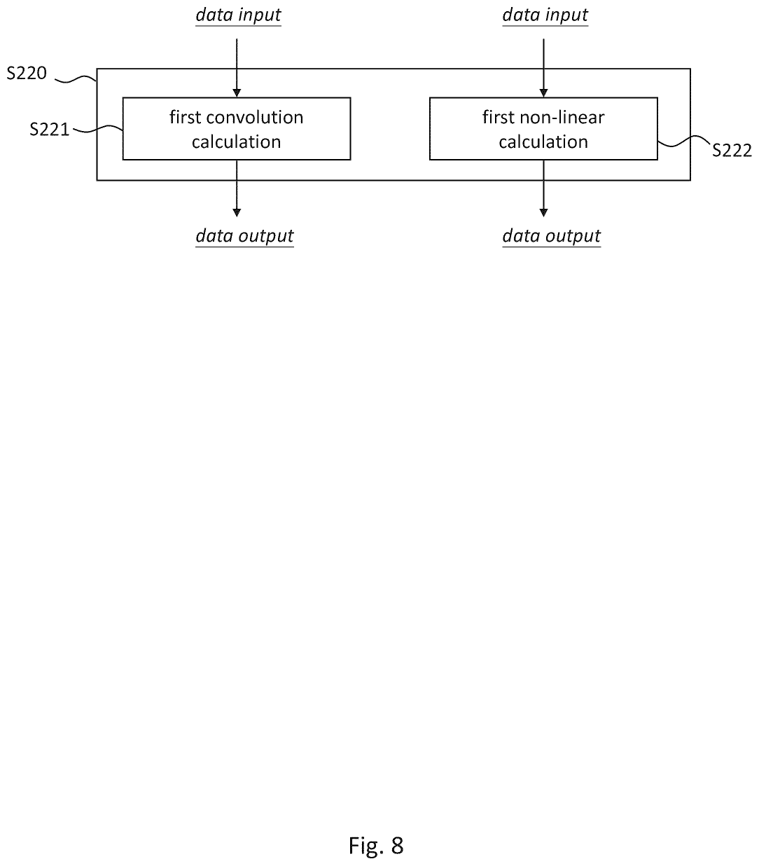

Now the description directs to step S220—the first-tier calculation. Please refer to FIG. 8, which is a flow chart of the first-tier calculation according to one embodiment of the invention.

Step S220 of the present embodiment includes step S221—the first convolution calculation and step S222—the first non-linear calculation. Steps S221 and S222 can be performed at the same time; or they can be performed in orderly fashion. Their priorities are not limited herein.

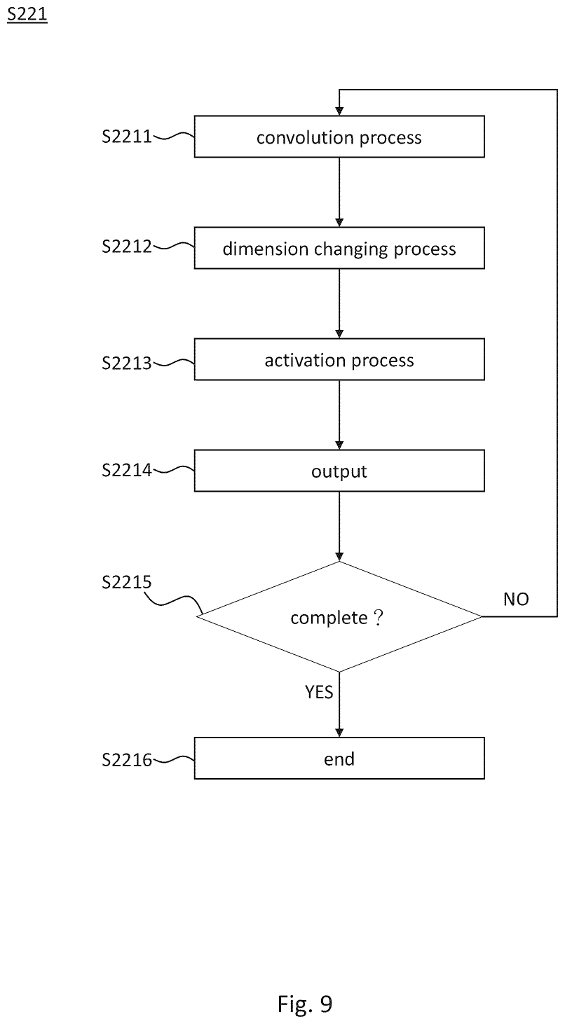

The first convolution calculation of step S221 will be elaborated in more detail. Please refer to FIG. 9, which is a flow chart of the first convolution calculation according to one embodiment of the invention. The implementation conditions for the first convolution calculation S221 are the same as those of the training method S200 and will not be repeated here. Step S221 of the first convolution calculation begins with step S2211.

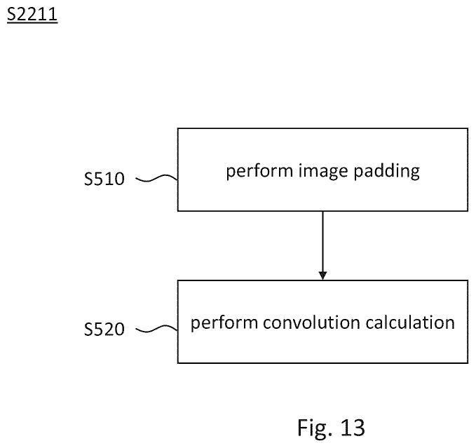

Step S2211: a convolution process is performed based on the received image data. In the convolution process S2211, a mask smaller than the size of the image data is used to slide pixel by pixel across the image data. A pixel value in the image data is calculated through a sum of products operation according to the mask, and thus a convolution result is generated therefrom. One example of the convolution process S2211 will be elaborated later with FIG. 13. After step S2211, an optional step S2212, an optional step S2213, or a step S2214 is performed.

In optional step S2212, a dimension changing process is performed, where a dimension of the convolution result is changed. For example, a rectified linear unit is used to change the dimension of the convolution result. Next, optional step S2213 or step S2214 is performed.

In optional step S2213, an activation process is performed, where the convolution result is updated based on an activation function. For example, a hyperbolic tangent function or a sigmoid function or the like is used to increase the nonlinearity of the convolution result. Next, the process flow moves on to step S2214.

In step S2214, the processed convolution result is output and is sent to step S230 to perform the combination computation.

In step S2215, whether the first convolution calculation S221 is completed or not is determined. The number of loops of executing the first convolution calculation S221 can be predetermined in accordance with different applications. In the case of NO, the current calculation result is sent back to step S2211 to repeat the convolution process until the predetermined number of the loops is reached and thus the determination is YES, the process continues to step S2216. Each loop of the calculation may include the optional step S2212 and/or step S2213.

In the training method S200, the first convolution calculation S221 is performed N times and an output of the n−1 time first convolution calculation S221 is regarded as the image data for the next n time first convolution calculation S221, where N≥2 and N≥n≥2. Step S230 is performed based on the output of the N time first convolution calculation S221 and the output of the first non-linear calculation S222.

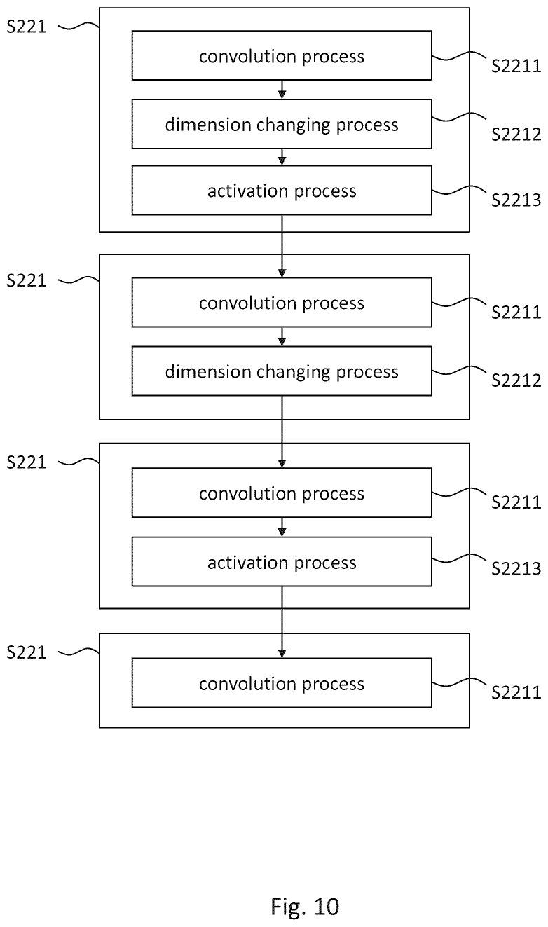

Please refer to FIG. 10, which is a flow chart of the first convolution calculation being performed four times according to one embodiment of the invention. The first convolution calculation S221 having four loops of calculations is provided, where N=4. In the first loop of calculation (n=1), step S2212 and step S2213 are performed after step S2211. In the second loop (n=2), only step S2212 is performed after step S2211. In the third loop (n=3), only step S2213 is performed after step S2211. In the fourth loop (n=4), neither step S2212 nor step S2213 is performed after step S2211, and the process flow moves to step S2214 of FIG. 9 to output the result.

Step S2216: the first convolution calculation S221 is ended.

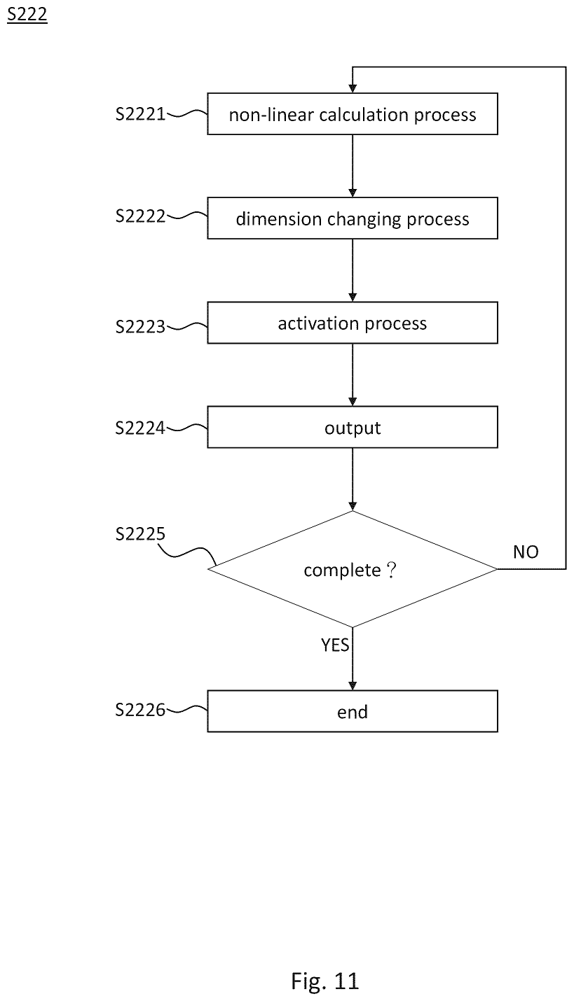

Please refer to FIG. 11, which is a flow chart of the first non-linear calculation according to one embodiment of the invention. The implementation conditions of the first non-linear calculation S222 are the same as those of the training method S00 and will not be repeated here. The first non-linear calculation S222 begins with step S2221.

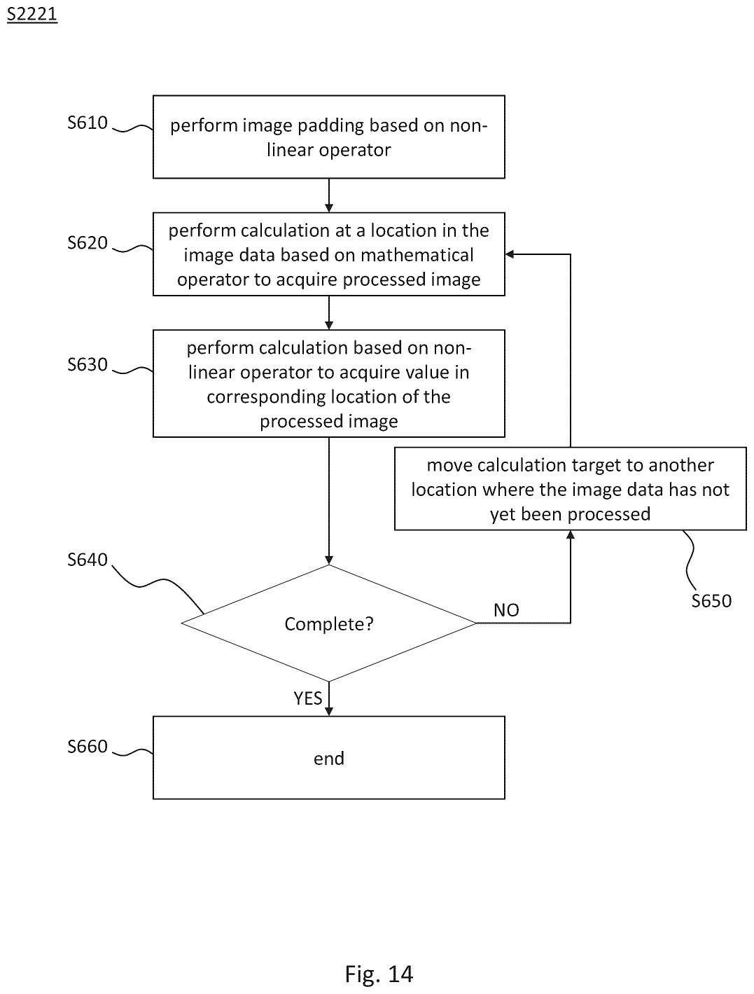

Step S2221: a non-linear calculation process S2221 is performed based on the input image data. In the non-linear calculation process S2221, similar to that in the convolution process S2211, a mask smaller than the size of the image data is used to slide pixel by pixel across the image data. An operation specified by a mathematical operator is performed on each pixel value in the image data. Then, a non-linear calculation is performed on the mathematical operation result by using a non-linear operator to generate a calculation result. One example of the non-linear calculation process S2221 will be elaborated in more detail later with FIG. 14. The mathematical operator is not necessary multiplication, it can also be addition, subtraction, division, and/or power value. The process then continues to the optional step S2222, optional step S2223, or step S2224.

In the optional step S2222, a dimension of the non-linear calculation result is changed. For example, a rectified linear unit is used to change the dimension of the non-linear calculation result. Next, the optional step S2223 or step S2224 is performed.

In the optional step S2223, the non-linear calculation result is updated based on an activation function. For example, a hyperbolic tangent function or a sigmoid function or the like is used to increase the nonlinearity of the non-linear calculation result. Next, the process flow moves on to step S2224.

In step S2224, the non-linear calculation result is output and is sent to step S230 to perform the combination computation.

In step S2225, whether the first non-linear calculation S222 is completed or not is determined. The number of loops of executing the first non-linear calculation S222 can be predetermined in accordance with different applications. In the case of NO, the current calculation result is sent back to step S2221 to repeat the non-linear calculation process until the predetermined number of the loops is reached and thus the determination is YES, the process continues to step S2226. Each loop of the calculation may include the optional step S2222 or step S2223.

In the training method S200, the first non-linear calculation S222 is performed M times and an output of the m−1 time first non-linear calculation S222 is regarded as the image data for the next m time first non-linear calculation S222, where M≥2 and M≥m≥2. Step S230 is performed based on the output of the M time first non-linear calculation S222 and the output of the first convolution calculation S221.

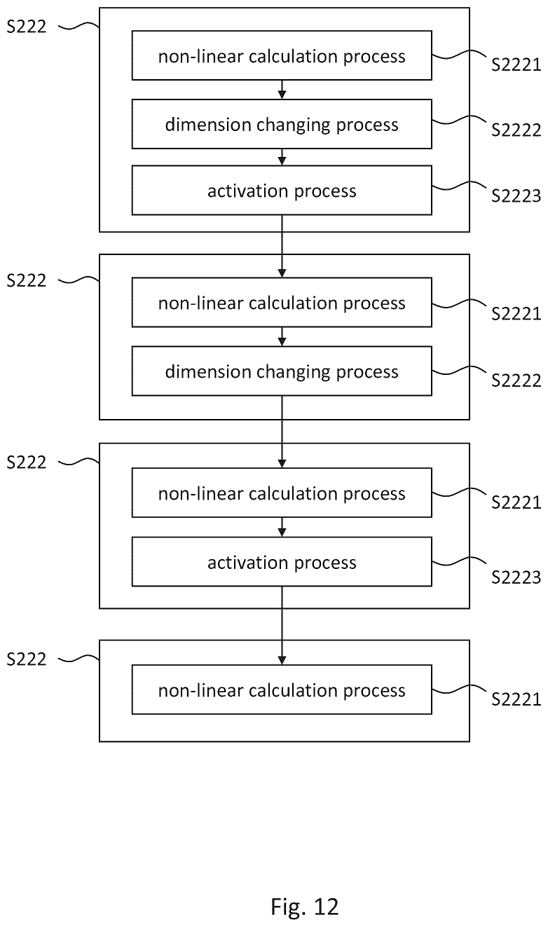

Please refer to FIG. 12, which is a flow chart of the first non-linear calculation being performed four times according to one embodiment of the invention. The first non-linear calculation S222 having four loops of calculation is provided, where M=4. In the first loop of calculation (m=1), step S2222 and step S2223 are performed after step S2221. In the second loop (m=2), only step S2222 is performed after step S2221. In the third loop (m=3), only step S2223 is performed after step S2221. In the fourth loop (m=4), neither step S2222 nor step S2223 is performed after step S2221, and the process flow moves to step S2224 of FIG. 11 to output the result.

Step S2226: the first non-linear calculation S222 is ended.

Please refer to FIG. 13, which is a flow chart of the convolution process S2211 according to one embodiment of the invention. The implementation conditions of the convolution process S2211 are the same as those of the training method S200 and will not be repeated. The convolution process S2211 begins with the optional step S510; alternatively, it can also begin with step S520.

In the optional step S510, a step of image padding is performed. Since the image size will be reduced in the following convolution step S520, the image can be first expanded with P row(s) at the top, P row(s) at the bottom, P column(s) at the left, and P column(s) at the right. In this manner, the image can maintain its original size after the operation of step S520. In other words, P circle(s) of expansion data is added around the image data, where P is a positive integer. The input data value in the P circle(s) of expansion data can be determined according to the non-linear operator. In one embodiment, the data value can be the minimum value of the range of the image data. For example, when the range of the image data is 0-255, the input data value is 0. Other embodiments of the invention also allow the increment in the size of the image data after convolution.

In step 520, a mask smaller than the size of the image data is used to slide across the image data based on strides. A pixel value in the image data is calculated through a sum of products operation according to the mask, and thus a convolution result is generated. For example, when the mask is a 3×3 matrix having nine mask values, a target pixel value in the image data and its eight neighboring pixel values are acquired, that is, a total number of nine values are acquired. Then the nine values are respectively multiplied by the nine mask values correspondingly, resulting in nine products. The sum of the nine products is then input into a corresponding location in the convoluted image data. The mask then moves to the next target pixel by a stride, and the operation repeats. After all the pixels in the image data have completed the above-mentioned operation, all the pixel values of the convoluted image data are acquired.

Please refer to FIG. 14, which is a flow chart of the non-linear calculation process S2221 according to one embodiment of the invention. The implementation conditions of the non-linear calculation process S2221 are the same as those of the training method S200 and will not be repeated. The non-linear calculation process S2221 includes four input factors: the input image data, the mask, the mathematical operator (IM-Operator), and the non-linear operator (NL-Operator). The non-linear calculation process S2221 begins with optional step 610; or alternatively begins with step 620.

Assuming the input image size is i×j, the input image can be represented as a 2-dimensional matrix (Img). The pixel value in the xth row and the yth column is Img(x,y), where 1<=x<=i, 1<=y<=j, and x, y, i, and j are all positive integers. Assuming the size of the mask is a×b, the mask can also be represented as a 2-dimensional matrix (Mask). The mask value in the xth row and yth column is Mask(x,y), where 1<=x<=a, 1<=y<=b, and x, y, a, and b are all positive integers. The IM-Operator includes one or any combination of the following: addition, subtraction, multiplication, division, and power value. The NL-Operator includes one or any combination of the following: acquiring a maximum value (max), acquiring a minimum value (min), and acquiring a mean value (avg). In one embodiment, the non-linear calculation (NLD) can be expressed in the following equation (7):

NLD(Img,Mask,IM-Operator,NL-Operator)(x,y)=

$$\begin{matrix}NL - Operator \\ i ∈ Ma , j ∈ Mb\end{matrix} ( Img ( x - i , y - j ) [ IM - Operator ] Mask ( i , j ) ) \qquad ( 7 )$$

In the optional step S610, a step of image padding is performed. Since the image size will be reduced in the following calculation step S620, the image can be first expanded with P row(s) at the top, P row(s) at the bottom, P column(s) at the left, and P column(s) at the right. P is a positive integer. In this manner, the image can maintain the original size after the following operations. In other words, P circle(s) of expansion data is added around the image data. The input value in the P circle(s) of expansion data can be determined according to the NL-Operator. Other embodiments of the invention also allow the increment in the size of the image data after calculation.

In one embodiment, when the NL-Operator is set to acquire the maximum value (max), the input value in the expansion data is the minimum value of the image data. For example, when the value of the image data ranges from 0 to 255, the input value is 0. When the NL-Operator is set to acquire the minimum value (min), the input value in the expansion data is the maximum value of the image data. For example, when the value of the image data ranges from 0 to 255, the input value is 255. In another embodiment, when the NL-Operator is set to acquire the mean value (avg), the input value equals the nearest pixel value in the image data. In yet another embodiment, when the value of the image data ranges from 0 to 255, the input value is the median number, e.g., 127. In an alternative embodiment, the input value is the average of more than one nearest pixel value of the image data.

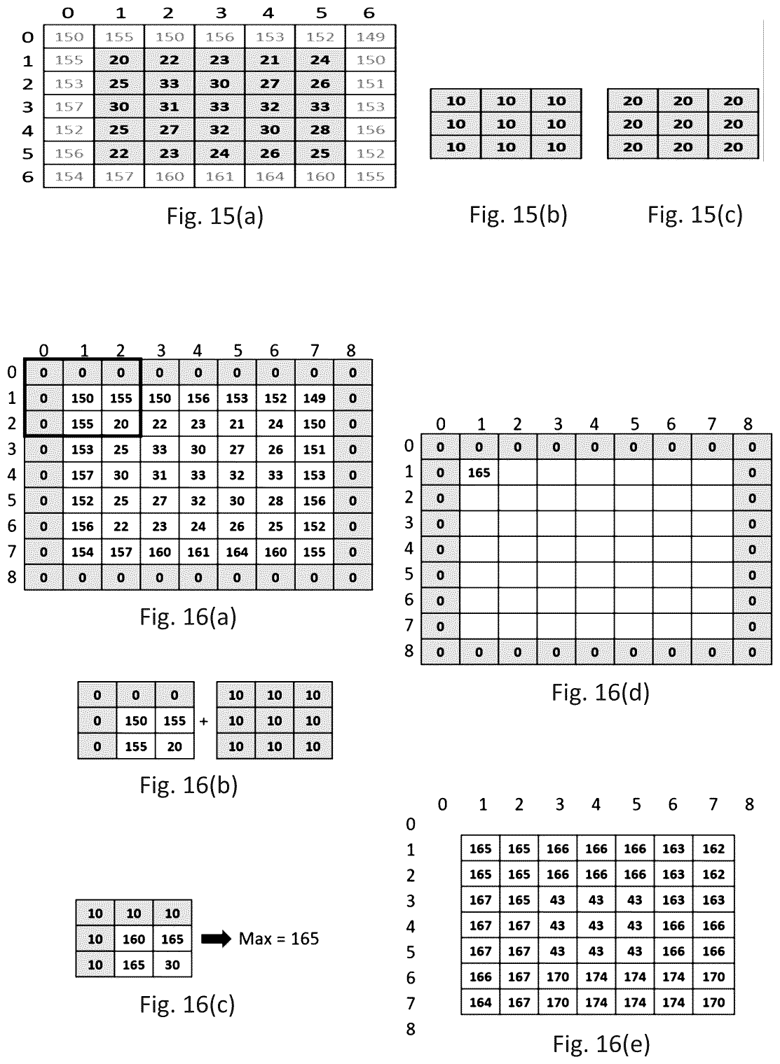

Please refer to FIG. 15(a), which is one example of the input image data, whose size is 7×7. Please also refer to FIG. 16(a), which is the padded image of the input image data of FIG. 15(a) after step S510 or step S610. Since one circle of the expansion data is added outside the input image data, the padded image of FIG. 16(a) has a size of 9×9. The input value in the outmost circle is 0. According to the above description, the input value of step S510 can be the minimum pixel value in the image data. The input value of step S610 is determined according to the NL-Operator and the input image data.

Please refer to FIG. 15(b), which is the mask used in step S520 according to one embodiment of the invention. Please refer to FIG. 15(c), which is the mask used in step S620 according to one embodiment of the invention.

In step S620, a calculation is performed at a location in the image data based on the mathematical operator (IM-Operator) to acquire the processed image data. The location indicates a target pixel in the image data for calculation. The mask of FIG. 15(b) and the padded image of FIG. 16(a) are taken as examples to perform the calculation based on the mathematical operator (IM-Operator). In the embodiments shown in FIG. 16(a) to FIG. 16(e), the factors in equation (7) are NLD(Img, Mask, Add, Max), so as to conduct the calculation. The mathematical operator (IM-Operator) is “adding” and the non-linear operator (NL-Operator) is “acquiring the maximum value”. Please refer to FIG. 16(b), which is a schematic diagram showing the calculation at location Img(1,1) in step S620. When conducting the calculation at location Img(1,1), there are nine adding operations in total. Please refer to FIG. 16(c), which is a schematic diagram showing the calculation result at location Img(1,1); to be more specific, the table on the left of FIG. 16(c) shows the calculation result at the location Img(1,1).

In step S630, another calculation based on the non-linear operator (NL-Operator) is applied to the calculated image data after step S620, so that the value at the corresponding location of the outcome image data can be acquired. For example, in the embodiment shown in FIG. 16(c), the maximum value in the left table is 165. Please refer to FIG. 16(d), which is a schematic diagram of the value of the calculation result input in Img(1,1). The value at location Img(1,1) of the outcome image data is input with 165, which is the result of the non-linear calculation as shown in FIG. 16(c).

In step S640, whether all the image data have been processed or not is determined. When all the pixel values of the image data have been processed, the method continues to step S660; or otherwise continues to step S650.

In step S650, the calculation target (which indicates the pixel currently being calculated) is moved to another location where the pixel has not yet been processed, and then the method returns to step S620.

In step S660, the non-linear calculation process S2221 is ended. Please refer to FIG. 16(e), which is a schematic diagram showing step S660, where all the pixel values of the image data have been processed through the non-linear calculation step S2221. FIG. 16(e) shows the outcome image data.

The non-linear calculation process S2221 shown in FIG. 14 is performed sequentially. After one location in the image data is processed, the calculation target is moved to the next location (i.e., another pixel in the image data). However, one skilled in the related art would understand that in yet another embodiment, the non-linear calculation process S2221 of FIG. 14 can be modified to be performed in parallel. For example, step S620 can be modified to perform mathematical operations on all pixels at the same time, and step S630 can be modified to perform non-linear calculation on all pixels at the same time. So long as the capacity of the logic circuit and the memory circuit is sufficient, the non-linear calculation process S2221 can be accelerated.

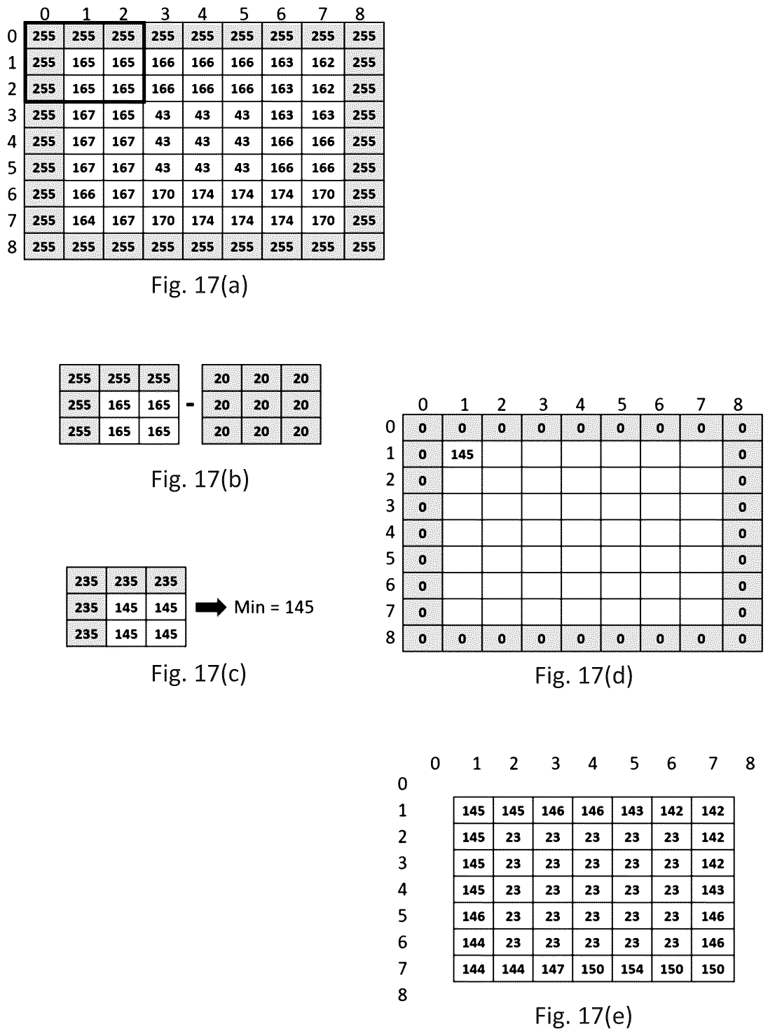

Please refer to FIG. 17(a) to FIG. 17(e), which show the schematic diagrams of the non-linear calculation process S2221 according to another embodiment of the invention. In this embodiment, the factors in the equation (7) are NLD(Img, Mask, Subtract, Min). The mathematical operator (IM-Operator) is “subtracting” and the non-linear operator (NL-Operator) is “acquiring the minimum value”. In step S610, one circle of expansion data is padded to the image data, P=1. The input value is the maximum value 255 of the range 0-255 when the non-linear operator indicates acquiring the minimum value. A mathematical operation process of step S620 is shown in FIG. 17(b). The nine values of the mask are respectively subtracted from the corresponding nine values relating to Image(1,1), and the result is shown in the left table of FIG. 17(c), which shows a non-linear calculation of step S630, where “145” is the minimum value among the nine values. Then, as shown in FIG. 17(d), the value “145” is input into the location Img(1,1). Finally, after 7×7=49 times of the process, the result is shown in FIG. 17(e), which shows the outcome image data.

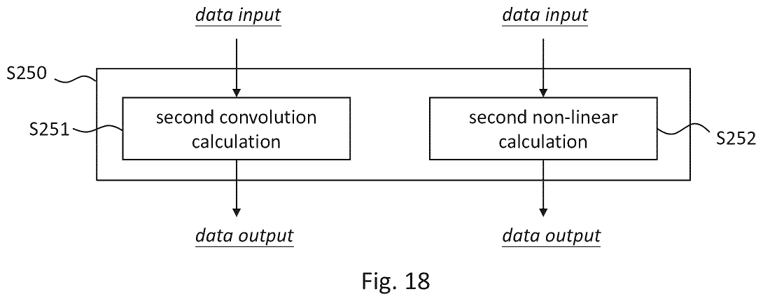

To sum up, the content of the first-tier calculation of step S220 (including the first convolution calculation S221 and the first non-linear calculation S222, as shown in FIG. 8) has been detailed in the above paragraphs. The description now directs to the second-tier calculation of step S250. Please refer to FIG. 18, which is a flow chart of the second-tier calculation according to one embodiment of the invention.

The second-tier calculation of step S250 includes step S251—a second convolution calculation and step S252—a second non-linear calculation. Step S251 and step S252 can be performed at the same time; or they can be performed in orderly fashion. Their priorities are not limited here.

The second convolution calculation S251 of the present embodiment can also include step S2211, the optional step S2212, the optional step S2213, and steps S2214 to S2216, which is the same as step S221 of FIG. 9. In one embodiment, the second convolution calculation S251 has the exact same steps as the first convolution calculation S221. Of course, based on actual needs, the number of the loops of executing step S251 and the specific steps within step S251 can be different from step S221. For example, the second convolution calculation S251 can have five loops of calculations. In the first loop and the second loop, step S2214 is directly performed after step S2211. Step S2212 and step S2213 are omitted. In the third loop, steps S2212 and S2213 are both performed after step S2211. In the fourth loop, only step S2212 is included. In the fifth loop, only step S2213 is included.

The second non-linear calculation S252 of the present embodiment can also include step S2221, the optional step S2222, the optional step S2223, and steps S2224 to S2226, which is the same as step S222 of FIG. 11. In one embodiment, the second non-linear calculation S252 has the exact same steps as the first non-linear calculation S222. Of course, based on actual needs, the number of the loops of executing step S252 and the specific steps within step S252 can be different from step S222. For example, the second non-linear calculation S252 can have five loops of calculations. In the first loop and the second loop, step S2224 is directly performed after step S2221. Step S2222 and step S2223 are omitted. In the third loop, steps S2222 and S2223 are both performed after step S2221. In the fourth loop, only step S2222 is included. In the fifth loop, only step S2223 is included.

According to the above-mentioned embodiments of the invention, in the training method S200 for neural network model, the received image data first goes through the first-tier calculation of step S220 including the first convolution calculation and the first non-linear calculation. Then in step S230, the combination computation is applied to the outputs of the first convolution calculation and the first non-linear calculation, so that linear and non-linear calculation results can be integrated more effectively in the training method S200. The variability of the feature space can be increased, which facilitates the development of a more robust and efficient deep learning network framework. The neural network model trained by the training method S200 according to the embodiments of the invention can effectively detect subtle image features. For example, the probability of finding early lesions from the medical images obtained by gastroscopy, colonoscopy, colposcopy and angioscopy can be increased. In addition, from the images of non-destructive inspection such as X-ray images and ultrasonic images, it is easier to find the weakness and the location of the flaws on the material.

The training system according to the embodiments of the invention will be elaborated below.

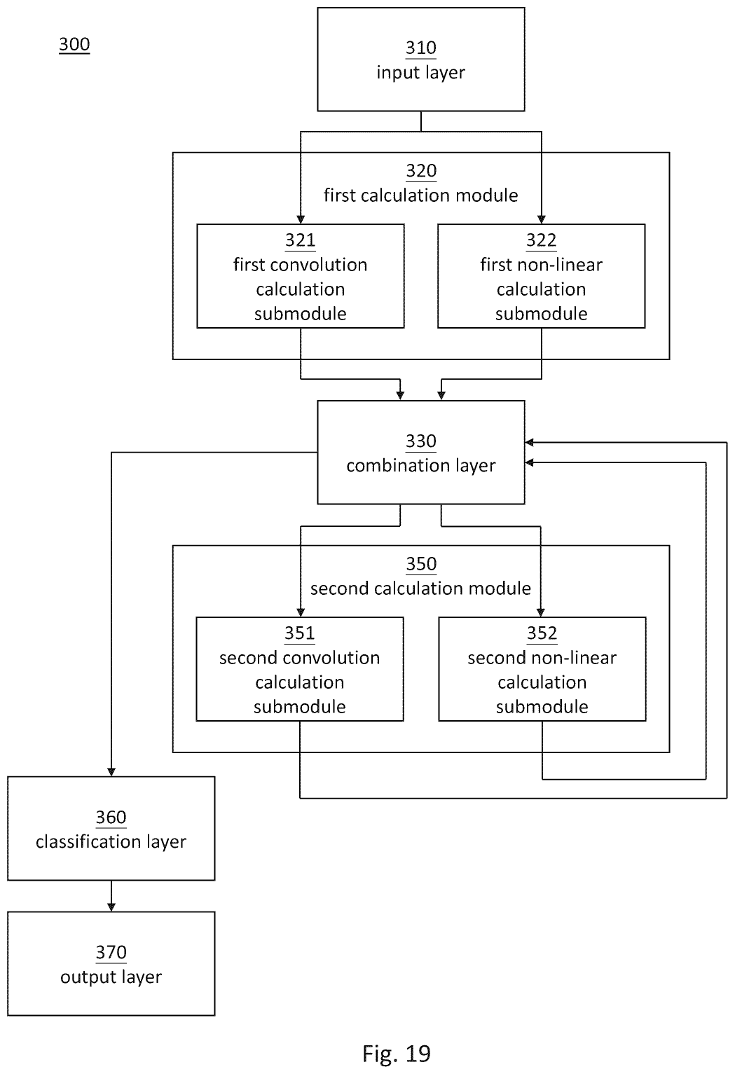

Please refer to FIG. 19, which is a schematic diagram of a training system according to one embodiment of the invention. The training system 300 at least includes an input layer 310, a first calculation module 320, a combination layer 330, a second calculation module 350, a classification layer 360, and an output layer 370. In the present embodiment, the previously mentioned training method (S200, as shown in FIG. 2) is performed by the training system 300. The input layer 310 is used for receiving the image data and outputs the received image data to the first calculation module 320. The first calculation module 320 is used for performing the first-tier calculation and sending the calculation result to the combination layer 330. The combination layer 330 is used for performing the combination computation and sending, based on actual needs, the computation result either to the second calculation module 240 or to the classification layer 360. The second calculation module 350 is used for performing the second-tier calculation and sending the calculation result to the combination layer 330. The classification layer 360 is used for classifying the image data after the combination computation. The output layer 370 is used for providing output of the training system 300.

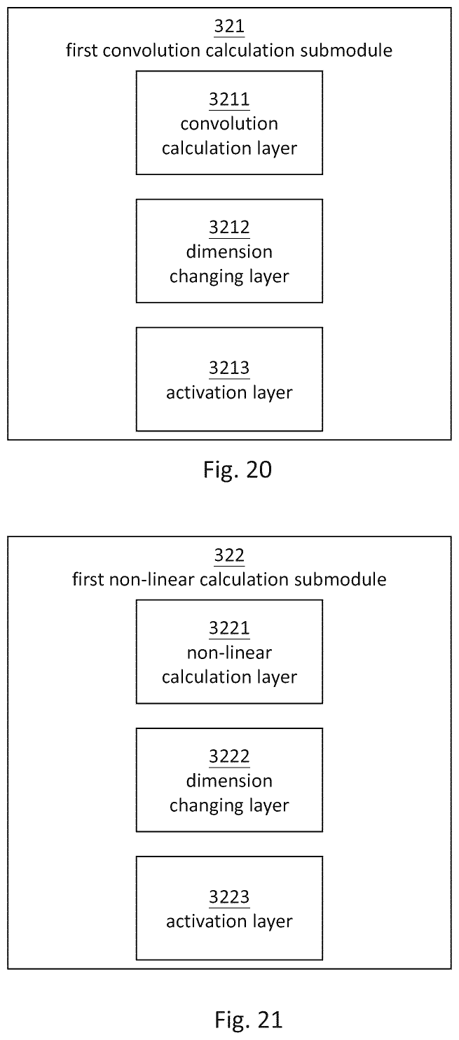

Please refer to FIGS. 19-21. FIG. 20 is a schematic diagram of the first convolution calculation submodule. FIG. 21 is a schematic diagram of the first non-linear calculation submodule. The first calculation module 320 includes a first convolution calculation submodule 321 and a first non-linear calculation submodule 322. The submodule 321 includes a convolution calculation layer 3211 for performing the convolution process. The submodule 321 can optionally include a dimension changing layer 3212 and an activation layer 3213 that are respectively used for the dimension changing process and the activation process.

The submodule 322 includes a non-linear calculation layer 3221 for performing the non-linear calculation process. The module 322 can optionally include a dimension changing layer 3222 and an activation layer 3223 that are respectively used for the dimension changing process and the activation process.

The second calculation module 350 of the present embodiment includes a second convolution calculation submodule 351 and a second non-linear calculation submodule 352. The submodule 351 can be the same or different from the submodule 321, and the submodule 352 can be the same as or different from the submodule 322.

According to one embodiment of the invention, a training method for a neural network model is provided. The method includes the following steps: (a) receiving an image data; (b) preforming a first-tier calculation including a first convolution calculation and a first non-linear calculation by using the image data; (c) performing a combination computation; (d) when a second-tier calculation is determined to be executed, performing the second-tier calculation including a second convolution calculation and a second non-linear calculation based on an output of the combination computation; and (e) when the second-tier calculation is determined not to be executed, classifying the output of the combination computation. The step (c) includes the following steps: (c1) grouping an output of the first-tier calculation; (c2) performing a linear computation and a non-linear computation respectively on different groups of the output of the first-tier calculation; and (c3) performing a consolidate computation based on an output of the linear computation and an output of the non-linear computation. The output of the combination computation is generated at least based on the image data after the first-tier calculation and one of a mathematical operator and a non-linear operator. The results of linear and non-linear calculation can be integrated more effectively.

In one embodiment, the output of the combination computation is further based on the image data after at least once of the second-tier calculation, thereby increasing the accuracy and efficiency of the neural network model.

In one embodiment, the second-tier calculation is performed W times, and the training method further includes: (f) determining whether a w+1 time second-tier calculation is performed or not, where w is an integer from 0 to W. The implementation flexibility can be increased.

In one embodiment, the first convolution calculation is performed N times and an output of the n−1 time first convolution calculation is regarded as the image data for the n time first convolution calculation, where N≥2 and N≥n≥2. Step (c) is performed based on the output of the N time first convolution calculation and an output of the first non-linear calculation, which is beneficial to the integration of linear and non-linear calculation.

In one embodiment, the first non-linear calculation is performed M times and an output of the m−1 time first non-linear calculation is regarded as the image data for the m time first non-linear calculation, where M≥2 and M≥m≥2. Step (c) is performed based on the output of the M time first non-linear calculation and an output of the first convolution calculation, which is beneficial to the integration of linear and non-linear calculation.

In one embodiment, the method further includes one or any combination of the following steps: changing a dimension of an output of the first convolution calculation and/or an output of the second convolution calculation; and updating the output of the first convolution calculation and/or the output of the second convolution calculation based on an activation function; thereby increasing calculation flexibility.

In one embodiment, the method further includes one or any combination of the following steps: changing a dimension of an output of the first non-linear calculation and/or an output of the second non-linear calculation; and updating the output of the first non-linear calculation and/or the output of the second non-linear calculation based on an activation function; thereby increasing calculation flexibility.

In one embodiment, the mathematical operator includes one or any combination of the following: addition, subtraction, multiplication, division, and power value. The linearity of the operator can be displayed more expressly.

In one embodiment, the non-linear operator includes one or any combination of the following: acquiring a maximum value, acquiring a minimum value, and acquiring a mean value. The non-linearity of operator can be displayed more expressly.

According to another embodiment of the invention, a training system for a neural network model is provided. The system includes an I/O interface and a processor. The I/O interface is configured for receiving an image data. The processor is configured for preforming a first-tier calculation including a first convolution calculation and a first non-linear calculation by using the image data and performing a combination computation including: grouping an output of the first-tier calculation; performing a linear computation and a non-linear computation respectively on different groups of the output of the first-tier calculation; and performing a consolidate computation based on an output of the linear computation and an output of the non-linear computation. The processor is further configured for performing a second-tier calculation including a second convolution calculation and a second non-linear calculation based on an output of the combination computation when the second-tier calculation is determined to be executed, and for classifying the output of the combination computation when the second-tier calculation is determined not to be executed. The output of the combination computation is generated at least based on the image data after the first-tier calculation and one of a mathematical operator and a non-linear operator. The results of linear and non-linear calculation can be integrated more effectively.

According to yet another embodiment of the invention, a training system for a neural network model is provided. The system includes a memory and a processor. The memory is configured for storing the neural network model. The processor is configured for performing a training method to train the neural network model. The training method includes: (a) receiving an image data; (b) preforming a first-tier calculation including a first convolution calculation and a first non-linear calculation by using the image data; (c) performing a combination computation; (d) when a second-tier calculation is determined to be executed, performing the second-tier calculation including a second convolution calculation and a second non-linear calculation based on an output of the combination computation; and (e) when the second-tier calculation is determined not to be executed, classifying the output of the combination computation. Step (c) includes the following steps: (c1) grouping an output of the first-tier calculation; (c2) performing a linear computation and a non-linear computation respectively on different groups of the output of the first-tier calculation; and (c3) performing a consolidate computation based on an output of the linear computation and an output of the non-linear computation. The output of the combination computation is generated at least based on the image data after the first-tier calculation and one of a mathematical operator and a non-linear operator. The results of linear and non-linear calculation can be integrated more effectively.

The training method and system for neural network model provided in the above-mentioned embodiments are used for training the linear and non-linear calculation parameters through deep learning. As a result, the features obtained by the neural network model have a higher degree of distinguishment, which is beneficial to the subsequent operations like classification. The neural network model trained therefrom is more sensitive to certain image features and can detect images with these subtle features more easily; thereby providing a robust and efficient deep learning network framework.

The ordinal numbers used in the detailed description and claims, such as “first” and “second” do not necessarily indicate their priority orders or up and down directions; on the contrary, they are merely intended to distinguish different members. It will be apparent to those skilled in the art that various modifications and variations can be made to the structure of the present invention without departing from the scope or spirit of the invention. In view of the foregoing, it is intended that the present invention covers modifications and variations of this invention, provided they fall within the scope of the following claims.

What is claimed is:

1. A training method for a neural network model, comprising:
(a) receiving an image data;
(b) preforming a first-tier calculation comprising a first convolution calculation and a first non-linear calculation by using the image data;
(c) performing a combination computation, comprising:
(c1) grouping an output of the first-tier calculation;
(c2) performing a linear computation and a non-linear computation respectively on different groups of the output of the first-tier calculation; and
(c3) performing a consolidate computation based on an output of the linear computation and an output of the non-linear computation;
(d) when a second-tier calculation is determined to be executed, performing the second-tier calculation comprising a second convolution calculation and a second non-linear calculation based on an output of the combination computation; and
(e) when the second-tier calculation is determined not to be executed, classifying the output of the combination computation;
wherein, the output of the combination computation is generated at least based on the image data after the first-tier calculation and one of a mathematical operator and a non-linear operator.

2. The training method according to claim 1, wherein the output of the combination computation is further based on the image data after at least once of the second-tier calculation.

3. The training method according to claim 1, wherein the second-tier calculation is performed W times, and the training method further comprises:
(f) determining whether a w+1 time second-tier calculation is performed or not, where w is an integer from 0 to W.

4. The training method according to claim 1, wherein the first convolution calculation is performed N times and an output of the n−1 time first convolution calculation is regarded as the image data for the n time first convolution calculation, where N≥2 and N≥n≥2, wherein the step (c) is performed based on the output of the N time first convolution calculation and an output of the first non-linear calculation.

5. The training method according to claim 1, wherein the first non-linear calculation is performed M times and an output of the m−1 time first non-linear calculation is regarded as the image data for the m time first non-linear calculation, where M≥2 and M≥m≥2, wherein the step (c) is performed based on the output of the M time first non-linear calculation and an output of the first convolution calculation.

6. The training method according to claim 1, further comprising one or any combination of the following steps:
changing a dimension of an output of the first convolution calculation and/or an output of the second convolution calculation; and
updating the output of the first convolution calculation and/or the output of the second convolution calculation based on an activation function.

7. The training method according to claim 1, further comprising one or any combination of the following steps:
changing a dimension of an output of the first non-linear calculation and/or an output of the second non-linear calculation; and
updating the output of the first non-linear calculation and/or the output of the second non-linear calculation based on an activation function.

8. The training method according to claim 1, wherein the mathematical operator comprises one or any combination of the following: addition, subtraction, multiplication, division, and power value.

9. The training method according to claim 1, wherein the non-linear operator comprises one or any combination of the following: acquiring a maximum value, acquiring a minimum value, and acquiring a mean value.

10. A training system for a neural network model, comprising:
an I/O interface configured for receiving an image data; and
a processor configured for preforming a first-tier calculation comprising a first convolution calculation and a first non-linear calculation by using the image data and performing a combination computation comprising: grouping an output of the first-tier calculation; performing a linear computation and a non-linear computation respectively on different groups of the output of the first-tier calculation; and performing a consolidate computation based on an output of the linear computation and an output of the non-linear computation;
wherein the processor is further configured for performing a second-tier calculation comprising a second convolution calculation and a second non-linear calculation based on an output of the combination computation when the second-tier calculation is determined to be executed and classifying the output of the combination computation when the second-tier calculation is determined not to be executed;
wherein the output of the combination computation is generated at least based on the image data after the first-tier calculation and one of a mathematical operator and a non-linear operator.

11. A training system for a neural network model, comprising:
a memory configured for storing the neural network model; and
a processor configured for performing a training method so as to train the neural network model, wherein the training method comprises:
(a) receiving an image data;
(b) preforming a first-tier calculation comprising a first convolution calculation and a first non-linear calculation by using the image data;
(c) performing a combination computation, comprising:
(c1) grouping an output of the first-tier calculation;
(c2) performing a linear computation and a non-linear computation respectively on different groups of the output of the first-tier calculation; and
(c3) performing a consolidate computation based on an output of the linear computation and an output of the non-linear computation;
(d) when a second-tier calculation is determined to be executed, performing the second-tier calculation comprising a second convolution calculation and a second non-linear calculation based on an output of the combination computation; and
(e) when the second-tier calculation is determined not to be executed, classifying the output of the combination computation;
wherein, the output of the combination computation is generated at least based on the image data after the first-tier calculation and one of a mathematical operator and a non-linear operator.
